(19) United States
(12) Patent Application Publication
(10) Pub. No.: US 2025/0307759 A1
(43) Pub. Date: Oct. 2, 2025

(54) Dynamic Generation and Updating of Item Storage Mapping Data

(71) Applicant: Zebra Technologies Corporation, Lincolnshire, IL (US)

(72) Inventors: Patrick Martin Brown, North Medford, NY (US); Jason M. Gang, Plainview, NY (US); Paul Seiter, Port Jefferson Station, NY (US); Kevin B. Mayginnes, Schaumburg, IL (US)

(21) Appl. No.: 18/621,683

(22) Filed: Mar. 29, 2024

(51) Int. Cl. G06Q 10/087; G06T 7/70; G06V 10/25; G06V 30/10

(52) U.S. Cl. CPC G06Q 10/087; G06T 7/70; G06V 10/25; G06V 30/10; G06V 2201/07

(57) ABSTRACT

A method includes: receiving a selection of an active operating mode selected from a generating mode and an updating mode; obtaining an image depicting a storage area; detecting, in the image, a label disposed on an item in the storage area; determining (i) an identifier of the label, and (ii) a location of the label in the storage area; determining whether the label is included in a map of the storage area; and when the label is not included in the map: (i) when the generating mode is active, inserting a record into the map, the inserted record containing the identifier of the label, and the location of the label, and (ii) when the updating mode is active, generating a notification via an output device.

### BACKGROUND

The transportation and delivery of items such as parcels to specified destinations may involve placement of the items into a container for transportation, such as a delivery vehicle, followed by sequenced retrieval and delivery of the items. Retrieving items from the vehicle for delivery may be time-consuming, reducing the efficiency of the delivery process.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for transport and delivery of items.

FIG. 2 is a flowchart of a method for dynamic generation and updating of item storage mapping data.

FIG. 3 is a diagram illustrating an example performance of blocks 205 to 210, and a partial performance of block 215, of the method of FIG. 2.

FIG. 4 is a diagram illustrating an example performance of label location determination at block 215 of the method of FIG. 2.

FIG. 5 is a diagram illustrating example results of the performance of blocks 205-215 of the method of FIG. 2.

FIG. 6 is a diagram of successively updated realogram generated via the method of FIG. 2.

FIG. 7 is a diagram illustrating an example performance of block 240 of the method of FIG. 2.

FIG. 8 is a diagram illustrating an example performance of block 245 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: receiving a selection of an active operating mode selected from a generating mode and an updating mode; obtaining an image depicting a storage area; detecting, in the image, a label disposed on an item in the storage area; determining (i) an identifier of the label, and (ii) a location of the label in the storage area; determining whether the label is included in a map of the storage area; and when the label is not included in the map: (i) when the generating mode is active, inserting a record into the map, the inserted record containing the identifier of the label, and the location of the label, and (ii) when the updating mode is active, generating a notification via an output device.

Additional examples disclosed herein are directed to a computing device, comprising: a camera; and a controller configured to: receive a selection of an active operating mode selected from a generating mode and an updating mode; obtain an image depicting a storage area; detect, in the image, a label disposed on an item in the storage area; determine (i) an identifier of the label, and (ii) a location of the label in the storage area; determine whether the label is included in a map of the storage area; and when the label is not included in the map: (i) when the generating mode is active, insert a record into the map, the inserted record containing the identifier of the label, and the location of the label, and (ii) when the updating mode is active, generate a notification via an output device.

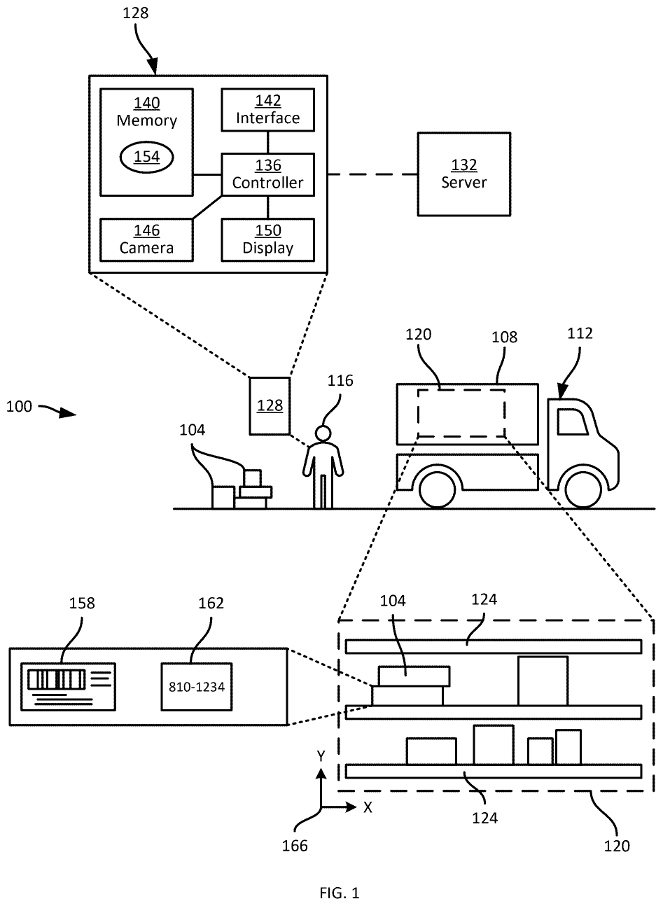

FIG. 1 depicts a system 100 for transport and delivery of items 104 such as parcels or the like to destinations such as residences, business, or the like. The transport of the items 104 to such destinations is also referred to as last mile delivery, and can be initiated by loading the items 104 into a storage area 108 of a vehicle 112. The vehicle 112, in the illustrated example, is a cube van, or the like, and the storage area 108 is the cargo area (e.g., the “box”) of the vehicle 112. A wide variety of other vehicles and corresponding storage areas are also contemplated, however. As will be apparent from the discussion below, the technologies implemented in the system 100 may also be deployed in other transport and logistics contexts beyond last mile delivery, such as for managing the loading and unloading of items 104 from shipping containers, aircraft, and the like.

The items 104 are loaded into the storage area 108, e.g., by an operator 116. In this example, the operator 116 is the operator of the vehicle 112, as well as the person responsible for removing items 104 from the vehicle 112 for delivery at various locations. In other examples, the items 104 can be loaded by a different person than the operator 116, and/or by multiple people, automated transport systems such as conveyors, or the like. A portion 120 of the storage area 108 is illustrated in FIG. 1, showing an example arrangement of the items 104 within the storage area 108. In the illustrated example, items 104 are placed on shelves 124 or other support structures, from which the items 104 are subsequently removed for delivery, e.g., when the vehicle 112 arrives at a destination.

The specific items 104 to be delivered by the operator 116 using the vehicle 112, e.g., for a given delivery route, can be defined in a manifest, which defines an ordered sequence of delivery locations (e.g., mailing addresses or the like). For each delivery location, the manifest can specify one or more item identifiers, indicating which items 104 are to be removed from the vehicle 112 and delivered to the corresponding location. The number of locations listed in the manifest, and the number of items per location (which may vary between locations), may be such that the vehicle 112 may contain tens or hundreds of items 104 for a given delivery route. The number of items 104 in the storage area 108 may be sufficient that locating one or more items 104 for a given delivery location may be a time-consuming process for the operator 116. Searching for items 104 in the storage area 108, in other words, can reduce the efficiency of the delivery process.

Some systems capture loaded locations of items 104 in the storage area 108, e.g., to provide directional guidance to the operator 116 at each delivery location. For example, such systems may instruct a loader (e.g., the operator 116 or another person) to place each item 104 at a specific position in the storage area 108. Other systems may implement processes by which the operator 116 or another suitable loader document the loaded location of each item 104 as the items 104 are being loaded. The above systems may, therefore, build a map of the items 104 within the storage area 108. Such a map can also be referred to as a realogram. However, items 104 can shift during transit, and the items 104 may also be moved by the operator 116 once loading is complete (e.g., to reposition certain items 104 before beginning the delivery run) and/or during transit, e.g., to retrieve other items 104 for delivery. A realogram generated by such systems once the items 104 have been loaded, in other words, may not remain accurate.

The system 100 implements functionality to generate a map of the items 104 within the storage area 108, and to dynamically and incrementally update the map throughout the loading and delivery processes. The functionality described herein may therefore improve the accuracy of the map, and may reduce the time spent searching for items 104 by the operator 116.

The system 100 includes a computing device 128, such as a mobile device carried or worn by the operator 116. The device 128 is configured, as discussed below, to capture images of portions of the storage area 108 during loading and/or delivery operations, and to generate and update a map (e.g., a realogram) indicating the locations of the items 104 within the storage area 108. The system 100 can also include a computing device, such as a server 132, configured to store maps generated by the device 128. In some examples, the server 132 can perform certain portions of the map generation and updating functions.

The device 128 includes a controller 136, such as a central processing unit (CPU), graphics processing unit (GPU) or the like, connected with a non-transitory computer readable medium such as a memory 140. The controller 136 and the memory 140 are implemented as one or more integrated circuits (ICs). The device 128 also includes a communications interface 142 enabling communication between the device 128 and other computing devices, such as the server 132, via suitable short-range links, networks, and the like. The device 128 includes a camera 146 configured to capture images, e.g., for processing by the controller 136. The device 128 further includes a display 150, controllable to present notifications and other information to the operator 116. The device 128 can also include other sensors in some examples, such as a radio frequency identifier (RFID) reader, a motion sensor such as an inertial measurement unit (IMU), and the like.

The memory 140 stores a plurality of applications executable by the controller 136, including a mapping application 154 whose execution by the controller 136 configures the controller 136 to perform various actions to capture images of the storage area 108, detect the items 104 therein, and generate and/or update a map defining the locations of the items 104 within the storage area 108. The functionality implemented via execution of the application 154 can also be implemented via a distinct, special-purpose controller such as a field-programmable gate array (FPGA), application-specific integrated circuit (ASIC), or the like, in other examples.

As described below, the device 128 is configured, via execution of the application 154, to detect labels on the items 104 and to use the detected labels to generate and update the realogram. As shown in FIG. 1, one or more labels can be disposed (e.g., affixed via adhesive, printed, or the like) on each item 104. For example, each item 104 can include a shipping label 158 including various information, such as a tracking number or other unique item identifier, a mailing address defining the delivery location, a name of the recipient, and the like. The label 158 can also include a machine-readable indicium, such as a one- or two-dimensional barcode, encoding the above information. The labels disposed on each item 104 can also include an auxiliary label 162, which can also be referred to as a “vision label”, “preload assist label”, or the like.

The auxiliary label 162 may omit some or all of the information contained on the label 158. In the illustrated example, the auxiliary label 162 includes a route identifier (e.g., “810”), shared by each item 104 designated for placement in the vehicle 112 for a given delivery route, and a stop identifier (e.g., “1234”), which can correspond to a particular delivery location on the delivery route. Certain items 104 may therefore share both of the above values (e.g., if the items 104 are destined for the same location). In some examples, the auxiliary labels 162 can also include an item identifier such as a portion of the corresponding tracking number, e.g., the final four digits or the like. The item identifier on an auxiliary label 162 need not uniquely identify the item 104, however.

The device 128 is configured to detect and interpret, e.g., via optical character recognition (OCR) or the like, the auxiliary labels 162, as the lower information content of the labels 162 in comparison with the labels 158 may facilitate extraction of information from the labels 162 as depicted in images containing multiple items. For example, barcodes on the labels 158 in images captured via the camera 146 depicting a portion of the storage area 108 (e.g., the portion 120, such as a set of shelves along one wall of the storage area 108) may be difficult to decode as a result of their small sizes in the images. Based on the detected positions of the labels 162, the device 128 can determine the locations of the labels 162 within the storage area 108, e.g., according to a three-dimensional coordinate system 166 established within the storage area 108 (two dimensions of which are shown in FIG. 1).

The locations of the labels 162 can be used to generate and/or update a map of the storage area 108. As described below, the device 128 can operate in either of a map generation mode, and a map updating mode. In the generation mode, new entries can be added to the realogram based on detected labels 162 in an image captured via the camera 146, e.g., representing items 104 placed in the storage area since the previous image was captured. In the updating mode, the addition of new entries to the map can be suppressed, and the device 128 may instead update locations for previously detected labels 162, while generating error notifications or the like for any newly detected items (e.g., labels 162 not previously present in the map).

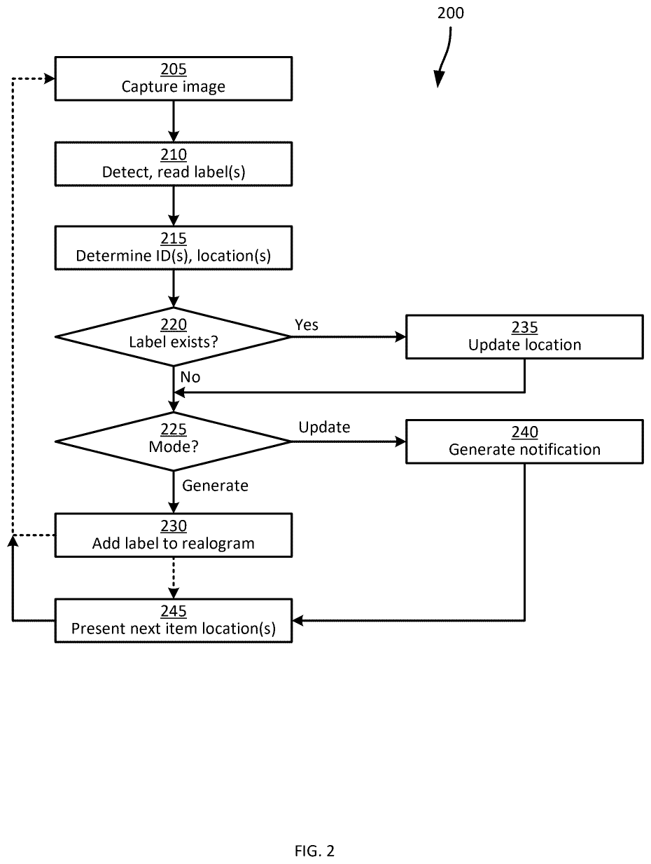

Turning to FIG. 2, a method 200 of dynamic generation and updating of item storage mapping data is shown. The method 200 will be described in conjunction with its performance in the system 100, and in particular by the device 128, via execution of the application 154.

At block 205, the device 128 is configured to capture an image depicting a portion of the storage area 108 with the camera 146. The image captured at block 205 can be, for example, a frame in a video stream captured by the device 128, e.g., as the operator 116 moves about the storage area 108. That is, the device 128 can be configured to capture images substantially continuously (e.g., at a frequency selected according to the computational resources available to the device 128 to process the images).

At block 210, the device 128 is configured to detect labels 162 depicted in the image from block 205, and to “read” the labels, e.g., by extracting one or more values from the information presented on each label 162. For example, the application 154 can include an object detection and classification model, e.g., based on You Only Look Once (YOLO) or another suitable classifier, trained on a set of images of auxiliary labels 162. The device 128 can, via the use of such a model, identify auxiliary labels 162 among other labels (e.g., the labels 158) and other objects in the image. For example, the output of the model can include bounding boxes or other regions of interest within the image, e.g., having pixel-based coordinates, each containing a label 162.

The device 128 can perform OCR on the regions of interest detected at block 210 to extract text from the labels 162. Based on the text extracted from the labels 162, at block 215 the device 128 can determine an item identifier corresponding to each label 162. The item identifier can include, for example, the stop identifier combined with a portion of the corresponding tracking number appearing on the label 162. The application 154 can, for example, implement a second classification model configured to identify sub-regions of interest within a region of interest output by the first model noted above, each sub-region corresponding to a value of the auxiliary labels 162 (e.g., the route number, the stop number, and the portion of a tracking number).

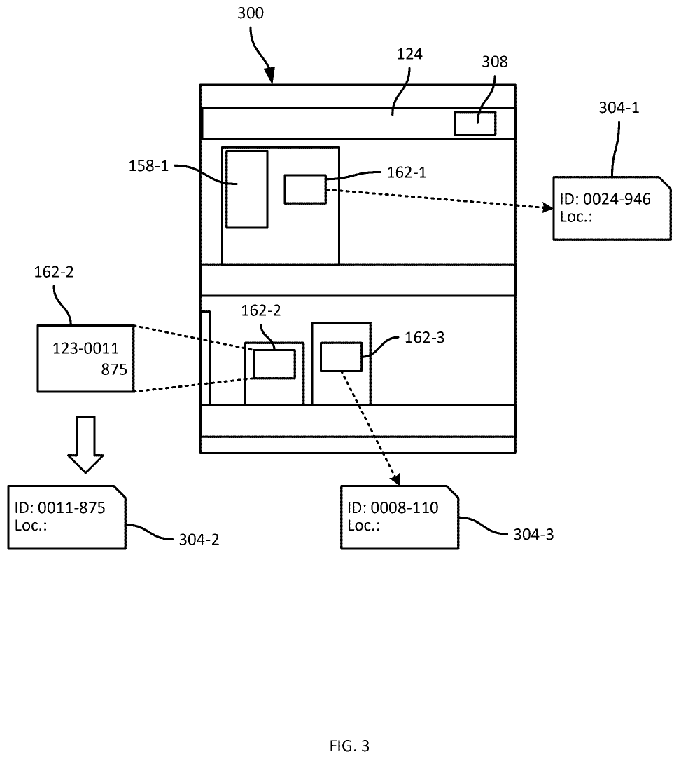

Referring to FIG. 3, an example image 300 is shown, e.g., as captured at block 205. The device 128 is configured, at block 210, to detect labels 162-1, 162-2, and 162-3, e.g., as bounding boxes with coordinates in an image coordinate system (e.g., defined by pixel coordinates). The device 128 is further configured to extract information such as the route number (e.g., “123” as shown in connection with the label 162-2), stop identifier (e.g., “0011”), and partial tracking number (e.g., “875”). From the extracted information, the device 128 can generate an identifier for each label 162. As shown in FIG. 3, the device 128 generates an item record 304-1, 304-2, 304-3 for each detected label 162, and determines an item identifier for each record 304. The item identifiers, in this example, are combinations of the stop identifier and the partial tracking number.

The device 128 also determines, at block 215, a location within the storage area 108 for each of the labels 162 detected at block 210. The locations determined at block 215 are defined in the coordinate system 166, e.g., in the form of a triplet of values (x, y, and z). In some examples, as shown in FIG. 1, the X axis of the coordinate system 166 is aligned with the length of the vehicle 112, and the Y axis is aligned with the height of the vehicle 112. AZ axis, which is orthogonal to the X and Y axes, can therefore be aligned with a width of the vehicle 112.

The device 128 can implement various locationing techniques to determine the locations at block 215. In some examples, the device 128 can also be configured to detect reference features disposed within the storage area 108, such as one or more anchor labels with predetermined locations in the coordinate system 166. An example anchor label 308 is shown in FIG. 3, affixed to a shelf 124 at a predetermined location within the storage area 108. A plurality of anchor labels can be placed in the storage area 108, and the device 128 can be provided with the locations of each anchor label. For example, the anchor label 308 can include text or the like that encodes coordinates of the anchor label 308. In other examples, the anchor label 308 can encode a unique identifier, and the device 128 can be configured to query the server 132 or a local repository (e.g., integrated with the application 154) to retrieve a location of the anchor label 308 based on the unique identifier.

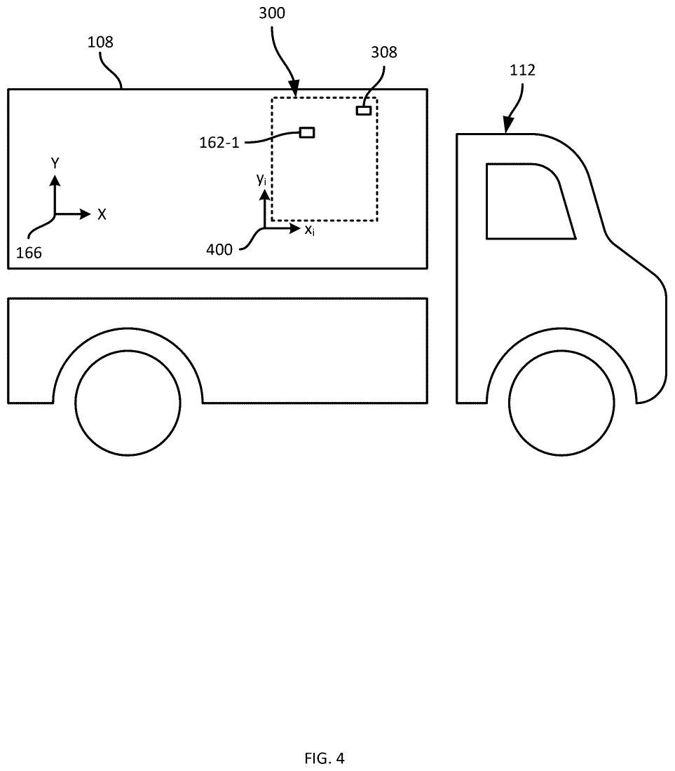

Turning to FIG. 4, the portion of the storage area 108 depicted by the image 300 is illustrated relative to the entire vehicle 112. The device 128 can determine a location of the anchor label 308 within the image 300, e.g., according to an image coordinate system 400. The device 128 can then determine, based on the retrieved location of the anchor label 308 in the coordinate system 166, a transform between the coordinate system 400 and the coordinate system 166, and apply the transform to the image coordinates of the labels 162 detected at block 210. The image coordinates of the anchor label 308 and the labels 162 are two-dimensional, therefore the device 128 can determine the third dimension (e.g., on the Z axis) based on predetermined sizes for the labels 162 and 308. For example, if the label 308 and the labels 162 have predetermined dimensions (e.g., three inches wide by two inches high, although a wide variety of other dimensions are also contemplated), the device 128 can determine a position of a label 162 on the Z axis of the system 166 based on the size of the label 162 relative to the size of the anchor label 308 in the image 300.

In other examples, reference features other than anchor labels 308 can be used for determining locations for the labels 162. Reference features can include structural features of the shelves 124, for example. In further examples, the device 128 can be configured to implement a pose tracking process, involving tracking the positions of features (e.g., surfaces, edges, corners, and the like) detected in sequential images captured via the camera 146. The positions of such features throughout the images, optionally combined with data from other sensors of the device 128 (e.g., an IMU), can be used to track movement of the device 128, e.g., in six degrees of freedom. More specifically, the device 128 can be configured to generate a sequence of poses in a local coordinate system, which can then be transformed into the coordinate system 166 via a registration process using the anchor label 308.

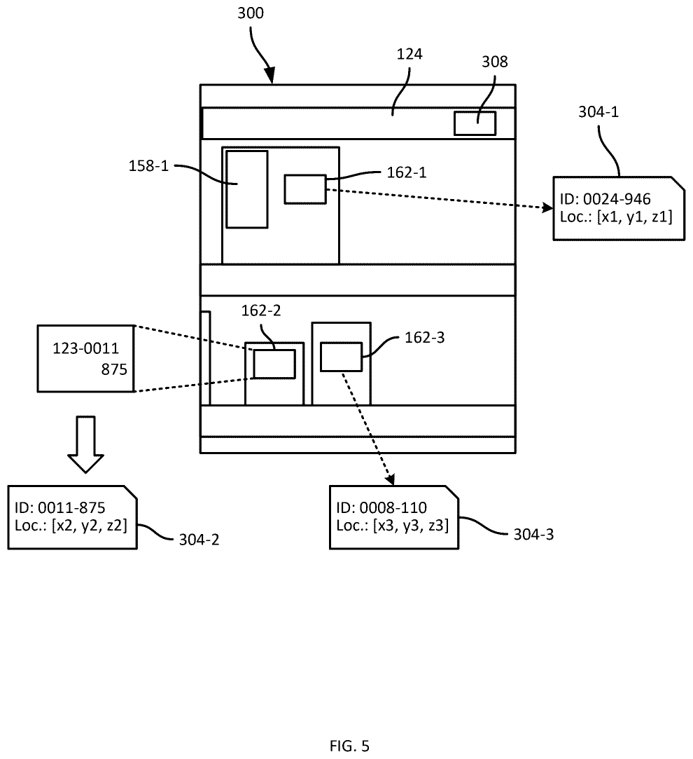

Turning to FIG. 5, the results of a performance of block 215 on the image 300 are shown. Each item record 304 includes, in addition to the item identifiers introduced in FIG. 3, an item location indicating the location of the corresponding label 162 in the coordinate system 166.

Returning to FIG. 2, in response to detecting the labels 162 and determining item identifiers and locations art blocks 205, 210, and 215, at block 220 the device 128 is configured to determine whether the labels 162 defined by each record 304 are present in a map of the storage area 108 stored in the memory 140 or otherwise accessible to the device 128 (e.g., via the server 132). In other words, the device 128 is configured to determine whether a given label 162 detected at block 205 has been previously detected, or whether the current detection of the label 162 is the first detection of that label 162.

When the determination at block 220 is negative, indicating that the label 162 has not previously been detected, the device 128 is configured to determine, at block 225, which of the operating modes mentioned above is active. The device 128 can store, e.g., in the memory 140, an indication of which operating mode is currently active, in response to a selection of which operating mode is active. In the generating mode, the device 128 is configured to permit the addition of newly detected labels 162 to the map, e.g., during loading of the vehicle 112 (at a transport and logistics facility, for example). When loading has been completed, the operator 116 can provide an input to the device 128 to switch from the generating mode to the updating mode (e.g., selecting the updating mode as the active operating mode), in which the addition of newly detected labels 162 to the map is no longer permitted. In the updating mode, the device 128 is configured to flag newly detected labels 162 as potentially misplaced, as described below.

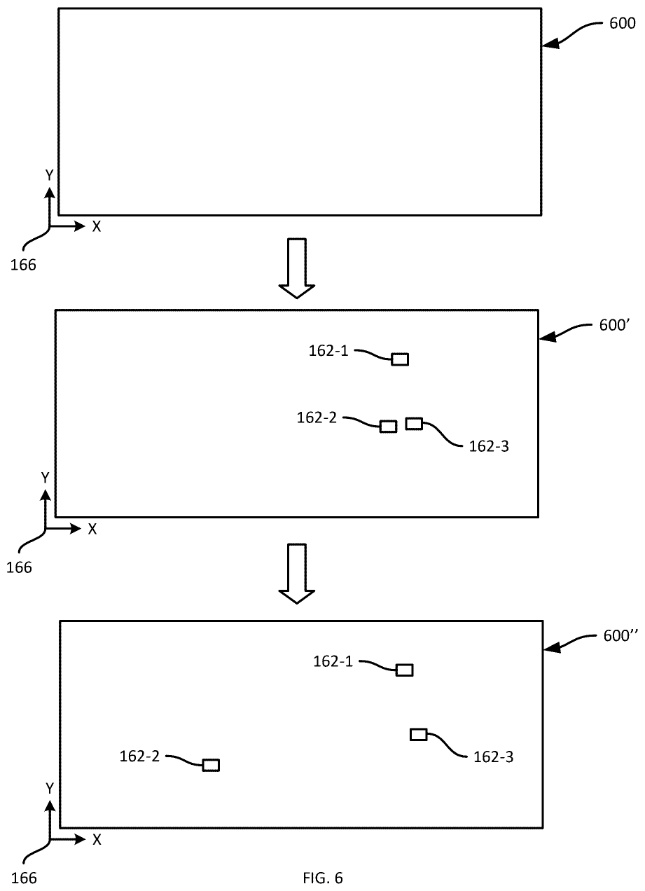

In the current example performance of the method 200, the generating mode is active (e.g., because loading has just begun). The device 128 therefore proceeds from block 225 to block 230, at which the device 128 adds entries to the realogram based on the performance of block 215. An initial realogram 600 is illustrated in the upper portion of FIG. 6, containing no entries. Following a performance of block 230, the realogram 600 is updated to the realogram 600′ shown in the middle portion of FIG. 6, in which the locations of the labels 162-1, 162-2, and 162-3 are represented.

Returning to FIG. 2, following block 230 the device 128 can return to block 205 to capture and process a further image as described above. In some examples, the device 128 can also generate directional guidance for retrieving items 104, based on the realogram. The presentation of directional guidance, however, can be omitted when in the generation mode, for example.

In a further example performance of the method 200, when the determination at block 220 is affirmative, e.g., because the label 162-2 has been detected in another captured image, the device 128 proceeds to block 235, regardless of the operating mode. The device 128 can, for example update the record 304-2 with the newly detected location, and as a result update the realogram 600′ to the realogram 600″ shown in the lower portion of FIG. 6. The device 128 can therefore dynamically update the locations of items 104 in the realogram, capturing movements of the items 104 during a delivery run, and/or during reorganization of the items 104 after loading is complete but before the vehicle 112 departs for the delivery run.

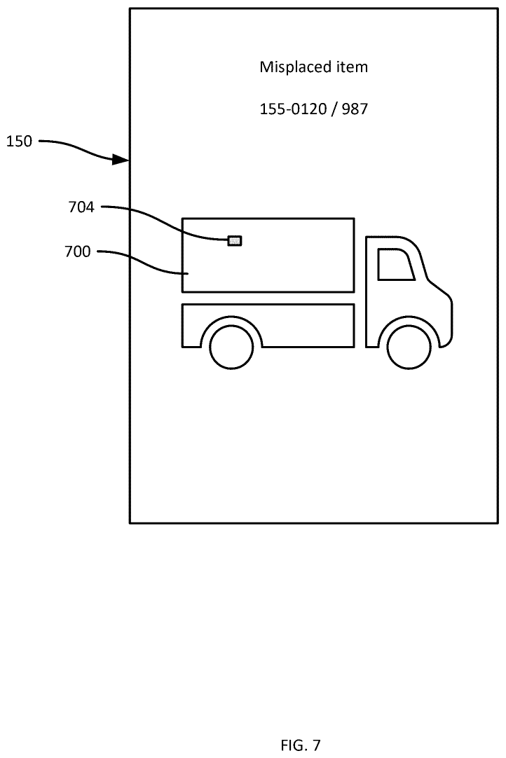

Referring again to FIG. 2, when the device is in the updating mode rather than the generating mode, in response to the detection of a new label 162 (e.g., a label 162 that is not already present in the realogram), the device 128 proceeds to block 240 instead of block 230. The updating mode can be used once loading of the storage area 108 is complete, such that no further items 104 are expected to be loaded. As a result, the detection of a new item 104 indicates a possibly misplaced item 104. At block 240, as shown in FIG. 7, the device 128 can be configured to generate a notification (e.g., on the display 150 and/or another suitable output device) indicating that a misplaced item has been located. As shown in FIG. 7, the device 128 can present an indication 700, such as a representation of the vehicle 112 along with a location marker 704 of the misplaced item. Although the detected location of the misplaced item is shown in the notification of FIG. 7, the detected location is not added to the realogram.

The notification can also include, as shown in FIG. 7, item identifying information, such as the content of the corresponding label 162 (e.g., the route number “155”, the stop number “0120”, and the partial tracking number “987”). The detection of potentially misplaced items in the updating mode may reduce the likelihood of the vehicle 112 departing a loading facility with incorrectly loaded items, and/or can facilitate the detection of such items after departure of the vehicle, while the operator 116 begins delivering items 104.

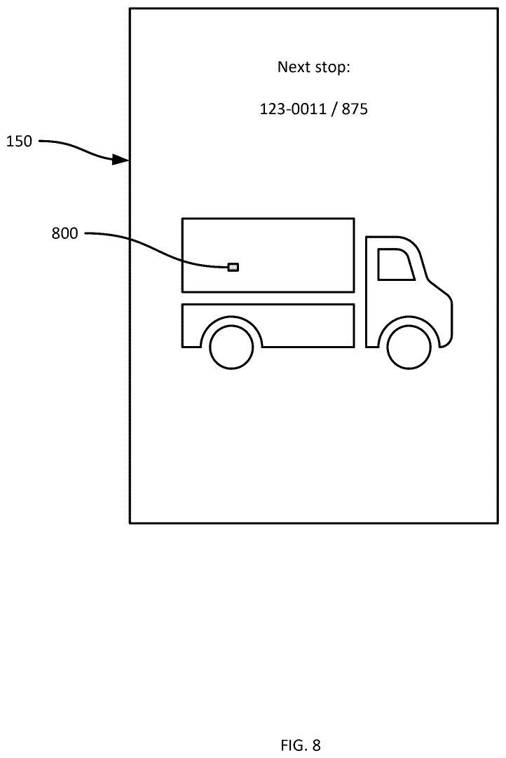

At block 245, e.g., when the device 128 operates in the updating mode, the device 128 can be configured to present directional guidance to the operator 116. For example, the device 128 can retrieve the next item from the manifest, and present an item identifier, mailing address, or the like, e.g., on the display 150, along with an indication of the most recently observed location of the corresponding label 162 in the realogram. FIG. 8 illustrates an example performance of block 245, in which an identifier of the label 162-2 is shown along with an indication 800 of the most recently observed location for the label 162-2 in the realogram.

As will be apparent, during a delivery run, items 104 are removed from the vehicle 112. Although the process of FIG. 2 does not delete entries from the realogram, entries may be removed in response to other events, such as a barcode scan or other indication received at the device 128 that an item 104 has been delivered and is therefore no longer on the vehicle 112.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
receiving a selection of an active operating mode selected from a generating mode and an updating mode;
obtaining an image depicting a storage area;
detecting, in the image, a label disposed on an item in the storage area;
determining (i) an identifier of the label, and (ii) a location of the label in the storage area;
determining whether the label is included in a map of the storage area; and
when the label is not included in the map:
(i) when the generating mode is active, inserting a record into the map, the inserted record containing the identifier of the label, and the location of the label, and
(ii) when the updating mode is active, generating a notification via an output device.

2. The method of claim 1, wherein the storage area includes an interior of a delivery vehicle.

3. The method of claim 1, wherein detecting the label includes executing a classifier to generate a position of the label in the image.

4. The method of claim 3, wherein determining the identifier of the label includes executing an optical character recognition model to extract the identifier from the position.

5. The method of claim 1, wherein determining the location of the label in the storage area includes:
detecting, in the image, a reference object in the storage area;
retrieving, from a memory, a location of the reference object in the storage area; and
determining the location of the label based on the location of the reference object and a position of the label in the image relative to the reference object.

6. The method of claim 1, wherein determining whether the label is included in the map of the storage area includes:
determining whether the map includes a record containing the identifier of the label.

7. The method of claim 1, further comprising:
when the label is included in the map, overwriting a previous location corresponding to the label with the location of the label.

8. The method of claim 1, wherein generating the notification includes:
generating, without updating the map, an indication that a misplaced item has been detected.

9. The method of claim 1, further comprising:
obtaining, from a sequence of identifiers corresponding to items in the storage area, a next identifier;
retrieving, from the map, a location corresponding to the next identifier; and
generating, via the output device, a notification indicating the location corresponding to the next identifier.

10. A computing device, comprising:
a camera; and
a controller configured to:
receive a selection of an active operating mode selected from a generating mode and an updating mode;
obtain an image depicting a storage area;
detect, in the image, a label disposed on an item in the storage area;
determine (i) an identifier of the label, and (ii) a location of the label in the storage area;
determine whether the label is included in a map of the storage area; and
when the label is not included in the map:
(i) when the generating mode is active, insert a record into the map, the inserted record containing the identifier of the label, and the location of the label, and
(ii) when the updating mode is active, generate a notification via an output device.

11. The computing device of claim 10, wherein the storage area includes an interior of a delivery vehicle.

12. The computing device of claim 10, wherein the controller is configured to detect the label by executing a classifier to generate a position of the label in the image.

13. The computing device of claim 12, wherein the controller is configured to determine the identifier of the label by executing an optical character recognition model to extract the identifier from the position.

14. The computing device of claim 10, wherein the controller is configured to determine the location of the label in the storage area by:
detecting, in the image, a reference object in the storage area;
retrieving, from a memory, a location of the reference object in the storage area; and
determining the location of the label based on the location of the reference object and a position of the label in the image relative to the reference object.

15. The computing device of claim 10, wherein the controller is configured to determine whether the label is included in the map of the storage area by:
determining whether the map includes a record containing the identifier of the label.

16. The computing device of claim 10, wherein the controller is configured to:
when the label is included in the map, overwrite a previous location corresponding to the label with the location of the label.

17. The computing device of claim 10, wherein the controller is configured to generate the notification by:
generating, without updating the map, an indication that a misplaced item has been detected.

18. The computing device of claim 10, wherein the controller is configured to:
obtain, from a sequence of identifiers corresponding to items in the storage area, a next identifier;
retrieve, from the map, a location corresponding to the next identifier; and
generate, via the output device, a notification indicating the location corresponding to the next identifier.
